(19) United States
(12) Patent Application Publication
(10) Pub. No.: US 2015/0345737 A1
(43) Pub. Date: Dec. 3, 2015

(54) LIGHT EMITTING DEVICE AND VEHICULAR LAMP

(71) Applicant: KOITO MANUFACTURING CO., LTD., Tokyo (JP)

(72) Inventors: Toru ITO, Shizuoka-shi (JP); Masaya SHIDO, Shizuoka-shi (JP); Naoki UCHIDA, Shizuoka-shi (JP)

(73) Assignee: KOITO MANUFACTURING CO., LTD., Tokyo (JP)

(21) Appl. No.: 14/727,221

(22) Filed: Jun. 1, 2015

(30) Foreign Application Priority Data
Jun. 3, 2014 (JP) 2014-114613

(51) Int. Cl. F21V 5/00; F21V 23/06; F21S 8/10

(52) U.S. Cl. CPC F21V 5/007; F21S 48/00; F21V 23/06

(57) ABSTRACT

A light emitting device includes a planar light emitting body that includes a light emitting portion having a planar surface from which light is emitted, and a non-light emitting portion from which light is not emitted, the non-light emitting portion being adjacent to the light emitting portion; and a transparent member which is disposed to cover the planar light emitting body, and which has a recessed portion provided at a position facing the non-light emitting portion.

### INCORPORATION BY REFERENCE

The disclosure of Japanese Patent Application No. 2014-114613 filed on Jun. 3, 2014 including the specification, drawings and abstract is incorporated herein by reference in its entirety.

### BACKGROUND OF THE INVENTION

1. Field of the Invention

The invention relates to a light emitting device and a vehicular lamp including the light emitting device.

2. Description of Related Art

There has been proposed a vehicular lamp in which a planar light emitting body, such as an organic electroluminescence (EL) panel, is used as a light source, in order to reduce the thickness and size of the vehicular lamp (for example, refer to Japanese Patent Application Publication No. 2011-150887 (JP 2011-150887A).

The organic electroluminescence panel includes light emitting regions from which light is emitted, and non-light emitting regions from which light is not emitted. In each of the light emitting regions, an anode, an organic substance layer, a cathode, and the like are disposed. The non-light emitting regions include a sealing portion and an auxiliary electrode. The non-light emitting regions are noticeable when the lamp is turned on or off. Thus, the design (appearance) of the light emitting device including the organic electroluminescence panel may be degraded, and accordingly, the design (appearance) of the vehicular lamp including the light emitting device may be degraded.

### SUMMARY OF THE INVENTION

The invention improves design (appearance) of a light emitting device including a planar light emitting body, and design (appearance) of a vehicular lamp.

An aspect of the invention relates to a light emitting device including: a planar light emitting body that includes a light emitting portion having a planar surface from which light is emitted, and a non-light emitting portion from which light is not emitted, the non-light emitting portion being adjacent to the light emitting portion; and a transparent member which is disposed to cover the planar light emitting body, and which has a recessed portion provided at a position facing the non-light emitting portion.

The planar light emitting body may include a plurality of light emitting panels disposed adjacent to each other; and the non-light emitting portion may include an abutting portion at which the light emitting panels abut each other.

The planar light emitting body may include an electrode provided to supply power to the light emitting portion; and the non-light emitting portion may include the electrode.

The recessed portion may have a triangular sectional shape. The recessed portion may have a sectional shape obtained by replacing an upper base of a trapezoidal shape with an arc. The recessed portion may have a trapezoidal sectional shape. Further, the recessed portion may have, for example, an arc sectional shape or an elliptic sectional shape.

Another aspect of the invention relates to a vehicular lamp including the light emitting device according to the above-mentioned aspect, the light emitting device being a light source of the vehicular lamp.

According to the above-mentioned aspects of the invention, it is possible to improve the design (appearance) of the light emitting device including the planar light emitting body, and design (appearance) of the vehicular lamp.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic sectional view illustrating a vehicular lamp according to an embodiment of the invention;

FIG. 2 is a schematic front view illustrating a light emitting device according to the embodiment of the invention;

FIG. 3 is a schematic side view illustrating the light emitting device according to the embodiment of the invention;

FIG. 4 is a schematic exploded perspective view illustrating the light emitting device according to the embodiment of the invention;

FIG. 5 is a schematic partial sectional view illustrating the light emitting device according to the embodiment of the invention;

FIG. 6 is a view used for describing the appropriate shape of a recessed portion;

FIG. 7 is a schematic partial sectional view illustrating a light emitting device according to another embodiment of the invention;

FIG. 8 is a view used for describing a recessed portion in a modified example; and

FIG. 9 is a view used for describing a recessed portion in another modified example.

### DETAILED DESCRIPTION OF EMBODIMENTS

Hereinafter, a light emitting device and a vehicular lamp according to an embodiment of the invention will be described in detail with reference to the drawings.

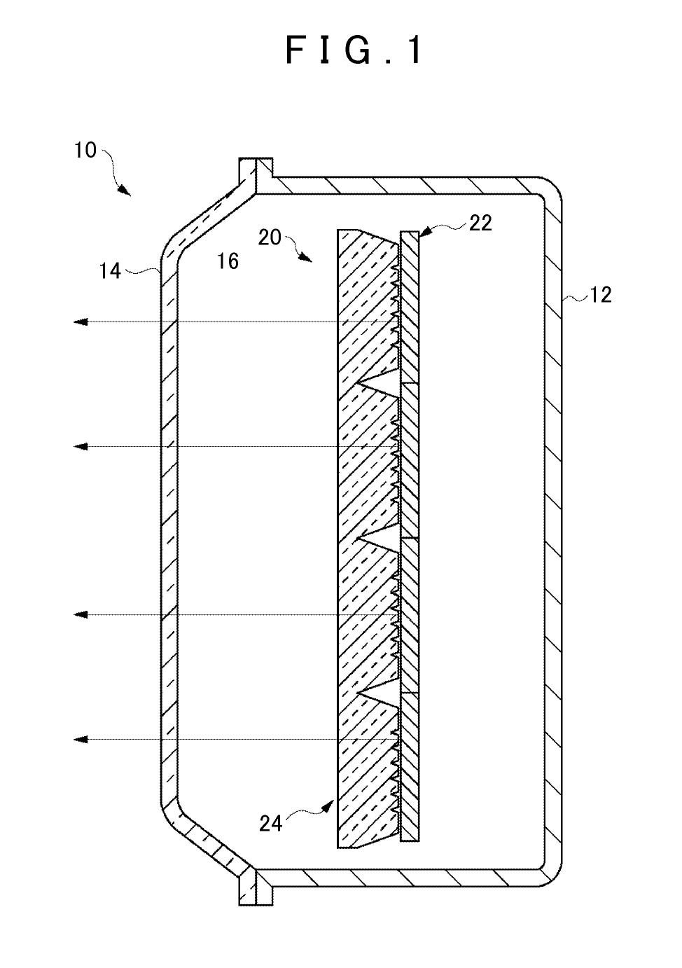

FIG. 1 is a schematic sectional view illustrating a vehicular lamp 10 according to the embodiment of the invention. As shown in FIG. 1, the vehicular lamp 10 includes a lamp body 12, a transparent front cover 14 that covers a front opening portion of the lamp body 12, and a light emitting device 20 provided in a lamp chamber 16 defined by the lamp body 12 and the front cover 14. The light emitting device 20 is fixed to the lamp body 12 with the use of a support member (not shown).

As shown in FIG. 1, the light emitting device 20 includes a planar light emitting body 22, and a transparent member 24 that is disposed to cover a light emitting surface of the planar light emitting body 22. Light emitted from the planar light emitting body 22 passes through the transparent member 24, and is emitted to the front of the lamp.

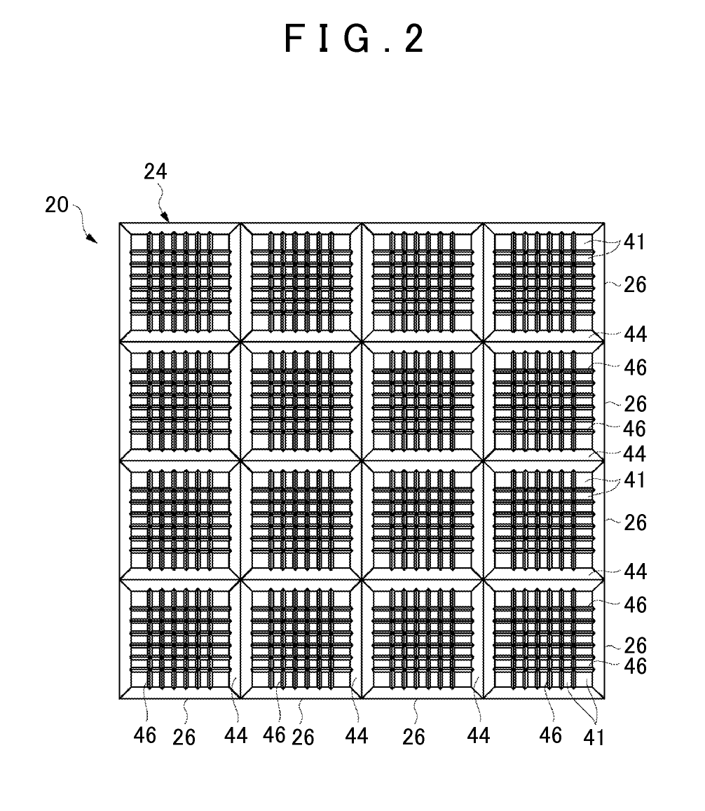

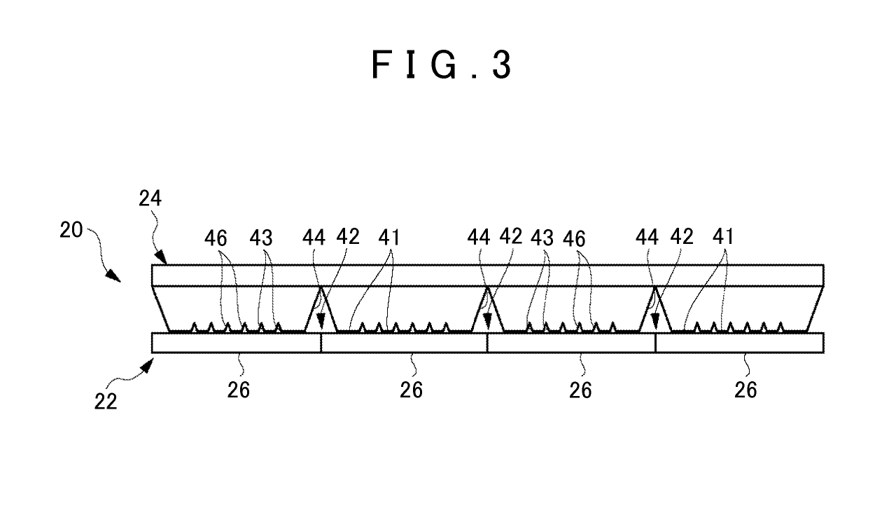

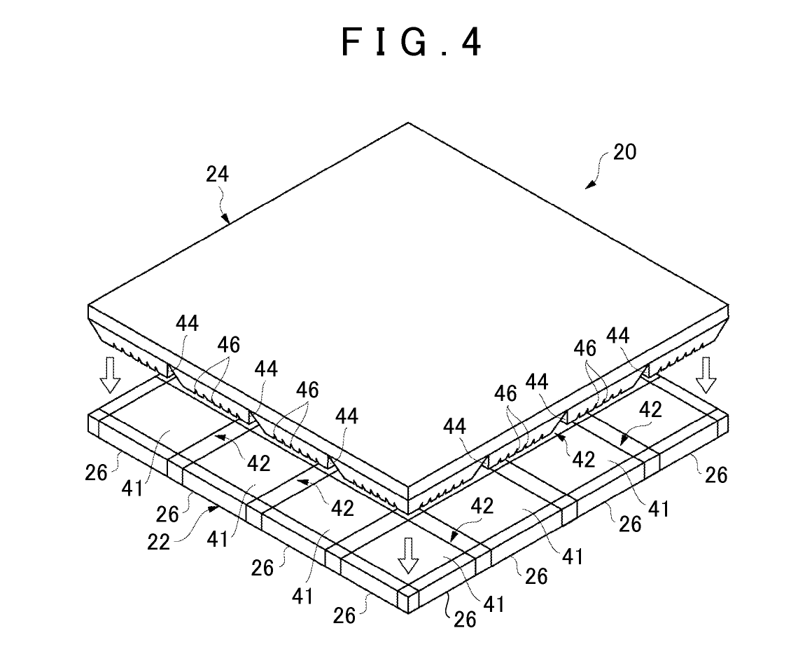

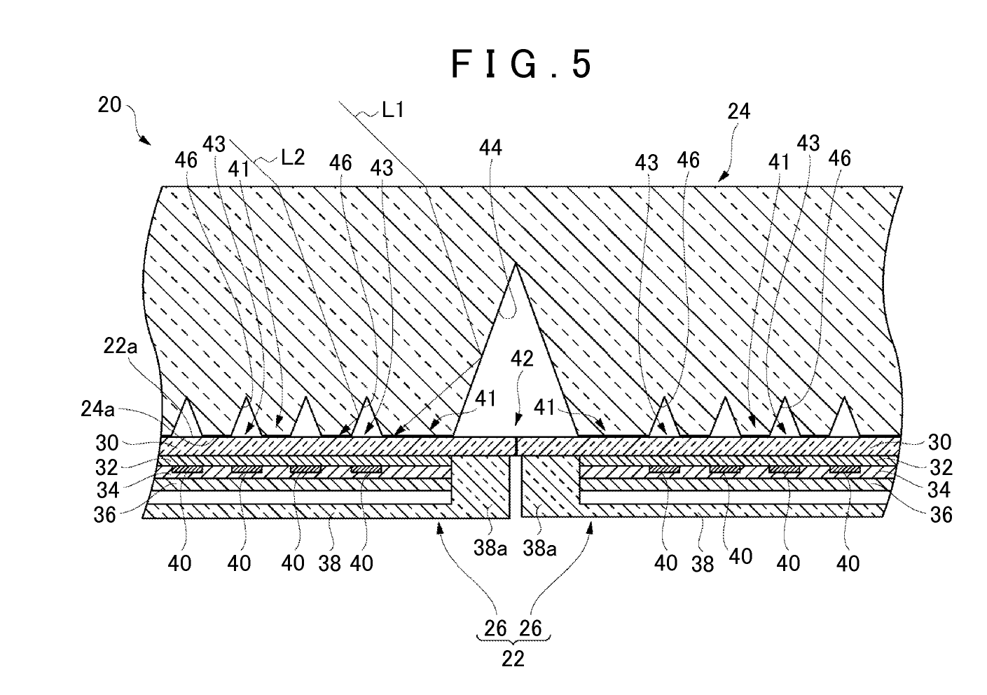

FIG. 2 is a schematic front view illustrating the light emitting device 20 according to the embodiment. FIG. 3 is a schematic side view illustrating the light emitting device 20 according to the embodiment. FIG. 4 is a schematic exploded perspective view illustrating the light emitting device 20 according to the embodiment. FIG. 5 is a schematic partial sectional view illustrating the light emitting device 20 according to the embodiment.

In the embodiment, the planar light emitting body 22 is formed by disposing a plurality of organic electroluminescence panels 26 adjacent to each other (the planar light emitting body 22 includes the plurality of organic electroluminescence panels 26 that are disposed adjacent to each other). In the embodiment, the four organic electroluminescence panels 26 are disposed adjacent to each other in a vertical direction, and the four organic electroluminescence panels 26 are disposed adjacent to each other in a horizontal direction (in other words, the sixteen organic electroluminescence panels 26 are disposed in total) to form the planar light emitting body 22.

As shown in FIG. 5, each organic electroluminescence panel 26 is formed by stacking an anode layer 32, an organic substance layer 34, and a cathode layer 36 on a glass substrate 30. Although not shown, a hole injection layer and a hole transport layer may be provided between the anode layer 32 and the organic substance layer 34. An electron transport layer may be provided between the organic substance layer 34 and the cathode layer 36. The organic substance layer 34 may be formed of a fluorescent organic compound, or a phosphorescent organic compound. The anode layer 32, the organic substance layer 34, and the cathode layer 36 are sealed by the glass substrate 30 and a sealing glass 38. The sealing glass 38 is fixed on the glass substrate 30 with the use of a support portion 38a provided at a peripheral edge portion of the sealing glass 38. The anode layer 32, the organic substance layer 34, and the cathode layer 36 may be sealed by a thin film, instead of the sealing glass 38.

In the organic electroluminescence panel 26, a transparent electrode, such as indium tin oxide (ITO), is used as the anode layer 32. Since the resistivity of the transparent electrode is high, if the anode layer 32 is used without any change, electric current may concentrate in the vicinity of a power supply portion, and accordingly, brightness unevenness and early deterioration may be caused. Therefore, in order to reduce the resistivity of the anode layer 32, auxiliary electrodes 40 are provided on the anode layer 32. The auxiliary electrodes 40 are provided in a lattice pattern over the entire area of the anode layer 32.

When a voltage is applied to the organic electroluminescence panel 26, holes are injected from the anode layer 32 to the organic substance layer 34, and electrons are injected from the cathode layer 36 to the organic substance layer 34. Accordingly, an organic compound is excited by energy generated when the holes and the electrons are combined in the organic substance layer 34. Thus, light is emitted from planar surfaces. The light emitted from the organic substance layer 34 is emitted from the glass substrate 30. Thus, in the organic electroluminescence panel 26, basically, light is emitted from the planar surfaces of regions in which the anode layer 32, the organic substance layer 34, and the cathode layer 36 are provided (hereinafter, the regions having the planar surfaces from which light is emitted may be referred to as “light emitting portions 41”). The light emitted from the planar surfaces of the light emitting portions 41 passes through the transparent member 24, and is emitted to the outside.

As described above, the anode layer 32, the organic substance layer 34, and the cathode layer 36 are sealed by the glass substrate 30 and the sealing glass 38. Since the support portion 38a of the sealing glass 38 is provided along the peripheral edge portion of the glass substrate 30, the anode layer 32, the organic substance layer 34, and the cathode layer 36 are not provided in the peripheral edge portion of each organic electroluminescence panel 26. Accordingly, light is not emitted from the peripheral edge portion of each organic electroluminescence panel 26. Since light is not emitted from the peripheral edge portion of each organic electroluminescence panel 26, abutting portions, in each of which the plurality of organic electroluminescence panels 26 abut each other, are non-light emitting portions from which light is not emitted (hereinafter, the abutting portions, in each of which the plurality of organic electroluminescence panels 26 abut each other, may be referred to as “first non-light emitting portions 42”), in the planar light emitting body 22.

In each organic electroluminescence panel 26, even in the regions in which the anode layer 32, the organic substance layer 34, and the cathode layer 36 are provided, light is not emitted from regions in which the auxiliary electrodes 40 are provided, because light is blocked by the auxiliary electrodes 40 (hereinafter, regions in which the auxiliary electrodes 40 are provided may be referred to as “second non-light emitting portions 43”).

The planar light emitting body 22 according to the embodiment includes the light emitting portions 41 having the planar surfaces from which light is emitted, and the first non-light emitting portions 42 and the second non-light emitting portions 43 that are adjacent to the light emitting portions 41. If the planar light emitting body 22 is disposed by itself in the vehicular lamp 10, the first non-light emitting portions 42 and the second non-light emitting portions 43 may be noticeable when the lamp is turned on or off, and accordingly, the design (appearance) of the lamp may be degraded.

Thus, in the embodiment, the transparent member 24 is disposed to cover the light emitting surface of the planar light emitting body 22. The transparent member 24 is a thick plate member formed of, for example, transparent resin such as acrylic, or optical glass. A planar light emitting body-side surface 24a of the transparent member 24 contacts a transparent member-side surface 22a of the planar light emitting body 22 (that is, the planar light emitting body-side surface 24a contacts the outer surface of the glass substrate 30 of each organic electroluminescence panel 26).

In the planar light emitting body-side surface 24a of the transparent member 24, first recessed portions 44, each of which has a triangular sectional shape, are provided at positions adjacent to and facing the respective first non-light emitting portions 42 of the planar light emitting body 22. Each of the first recessed portions 44 extends along a direction in which the corresponding first non-light emitting portion 42 extends. In the embodiment, the first recessed portion 44 has a shape of an isosceles triangle with the first non-light emitting portion 42 serving as a base, in a sectional view.

Further, in the planar light emitting body-side surface 24a of the transparent member 24, second recessed portions 46, each of which has a triangular sectional shape, are provided at positions adjacent to and facing the respective second non-light emitting portions 43 of the planar light emitting body 22. In the embodiment, each of the second recessed portions 46 extends in a direction in which the corresponding second non-light emitting portion 43 extends. In the embodiment, the second recessed portion 46 has a shape of an isosceles triangle with the second non-light emitting portion 43 serving as a base, in a sectional view.

In the embodiment, at least part of light, which is directed toward the first non-light emitting portions 42 and the second non-light emitting portions 43 after entering the transparent member 24 from the outside, is internally reflected at inclined surfaces of the first recessed portions 44 and the second recessed portions 46, and reaches the light emitting portions 41. That is, as shown in FIG. 5, if the first recessed portion 44 were not provided, a light beam L1 would reach the first non-light emitting portion 42. However, since the first recessed portion 44 is provided, the light beam L1 is not incident on the non-light emitting portion 42, and reaches the light emitting portion 41. Similarly, if the second recessed portion 46 were not provided, a light beam L2 would reach the second non-light emitting portion 43. However, since the second recessed portion 46 is provided, the light beam L2 is not incident on the second non-light emitting portion 43, and reaches the light emitting portion 41. As a result, as compared to the case where the transparent member 24 is not provided, the first non-light emitting portions 42 and the second non-light emitting portions 43 are unlikely to be visually recognized from the outside (in other words, it is difficult to visually recognize, from the outside, the first non-light emitting portions 42 and the second non-light emitting portions 43).

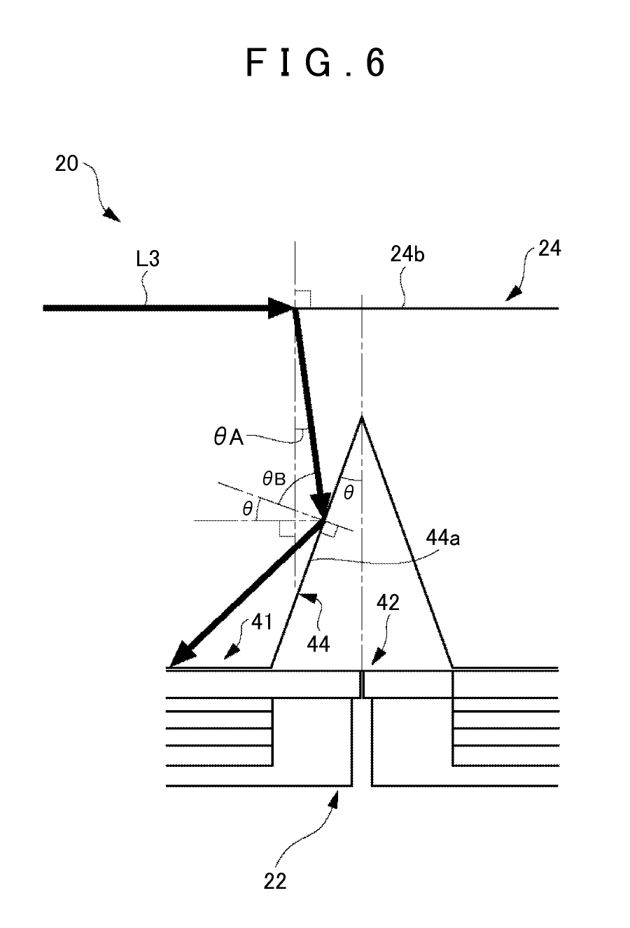

FIG. 6 is a view used for describing the appropriate shape of the recessed portion. An example, in which a light beam L3 enters a light emitting surface 24b of the transparent member 24 at an incidence angle of 90 degrees, will be described with a focus on the first recessed portion 44 as a representative example of the recessed portion.

When θ represents a half of an apex angle of the first recessed portion 44 having the isosceles triangular sectional shape, θ_{A} represents an output angle of the light beam L3, θ_{B} represents an incidence angle at which the light beam L3 is incident on an inclined surface 44a of the first recessed portion 44, “n” represents the refractive index of the transparent member 24, and θ_{C} represents a critical angle between the transparent member 24 and air, the following expression (1) is satisfied.

θ_{B}=90° −θ_{C} −θ. . . (1)

In order that the light beam L3 should be totally reflected at the inclined surface 44a and should not be incident on the first non-light emitting portion 42, the incidence angle θ_{B} needs to be larger than the critical angle θ_{C}. That is, θ needs to satisfy the following expression (2).

θ<90° −2θ_{C} . . . (2)

For example, when the transparent member 24 is formed of acrylic having a refractive index of 1.5, θ_{C} is equal to 41.8° (θ_{C} =41.8°). Accordingly, θ is smaller than 6.4° (θ<6.4°) based on the expression (2). That is, when the apex angle of the first recessed portion 44 with the isosceles triangular sectional shape is smaller than 12.8°, theoretically, the light beam L3 that is to enter the planar light emitting body-side surface 24a of the transparent member 24 is totally reflected at the inclined surface 44a of the first recessed portion 44, and reaches the light emitting portion 41. Accordingly, when the light emitting device 20 is seen from above the transparent member 24 at any angle, the first non-light emitting portion 42 cannot be visually recognized (in other words, when the light emitting device 20 is seen from above the transparent member 24, the first non-light emitting portion 42 cannot be visually recognized, regardless of the angle at which the light emitting device 20 is seen). Even when θ does not satisfy the expression (2), the first non-light emitting portion 42 may not be visually recognized, depending on the angle at which the light emitting device 20 is seen.

Thus, the light emitting device 20 according to the embodiment includes the transparent member in which the first recessed portions 44 are respectively formed at positions adjacent to and facing the first non-light emitting portions 42, and the second recessed portions 46 are respectively formed at positions adjacent to and facing the second non-light emitting portions 43. Therefore, it is impossible, or at least difficult to visually recognize the first non-light emitting portions 42 and the second non-light emitting portions 43. As a result, the first non-light emitting portions 42 and the second non-light emitting portions 43 are not noticeable, or are less noticeable when the lamp is turned on or off. Thus, the design (appearance) of the light emitting device 20 is improved, and accordingly, the design (appearance) of the vehicular lamp 10 including the light emitting device 20 is improved.

In general, as the size of the organic electroluminescence panel increases, the yield decreases. As the size of the organic electroluminescence panel increases, brightness unevenness is likely to increase. Further, in order to produce large-sized organic electroluminescence panels, a large-scale facility is required. Due to these factors, the cost of producing a large-sized organic electroluminescence panel tends to be high. Accordingly, it is conceivable to employ a method in which a plurality of organic electroluminescence panels with a relatively small size are disposed adjacent to each other to produce a large-sized planar light emitting body at low cost, as in the embodiment. However, in this case, abutting portions, in each of which the plurality of organic electroluminescence panels abut each other, are non-light emitting portions from which light is not emitted, and the abutting portions may be extremely noticeable. In this respect, in the light emitting device 20 according to the embodiment, the abutting portions, in each of which the organic electroluminescence panels abut each other, are made less noticeable, or unnoticeable by disposing the transparent member 24 on the planar light emitting body 22. Thus, it is possible to provide the light emitting device 20 with excellent design (appearance) at low cost, and to provide the vehicular lamp with excellent design (appearance) at low cost.

As described above, in the organic electroluminescence panel 26, auxiliary electrodes inevitably need to be provided in order to decrease the resistivity of the transparent electrode. The auxiliary electrodes are non-light emitting portions from which light is not emitted, and the auxiliary electrodes may be extremely noticeable. In this respect, in the light emitting device 20 according to the embodiment, the auxiliary electrodes are made unnoticeable, or less noticeable, by disposing the transparent member 24 on the planar light emitting body 22. Therefore, it is possible to decrease the resistivity of the transparent electrode, and to improve the design (appearance).

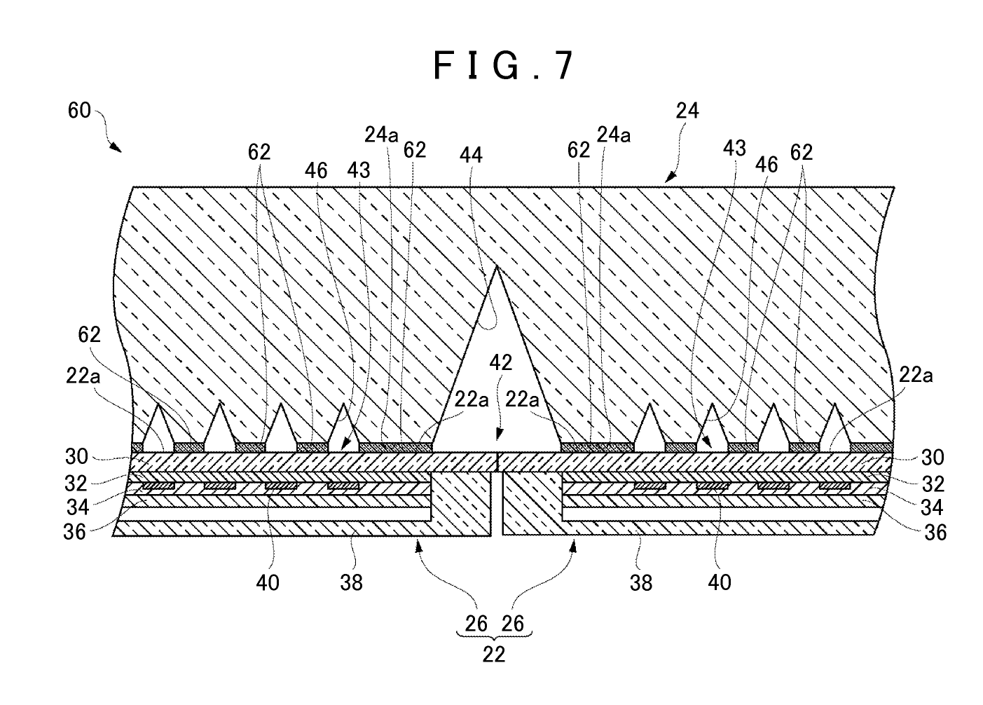

FIG. 7 is a schematic partial sectional view illustrating a light emitting device 60 according to another embodiment of the invention. In the light emitting device 60 shown in FIG. 7, the constituent elements that are the same as or correspond to the constituent elements of the light emitting device 20 are denoted by the same reference numerals, and redundant descriptions thereof will be appropriately omitted.

As shown in FIG. 7, in the light emitting device 60 according to the embodiment, a transparent adhesive layer 62 is provided between the transparent member-side surface 22a of the planar light emitting body 22 and the planar light emitting body-side surface 24a of the transparent member 24 so as to connect the transparent member 24 to the planar light emitting body 22. The transparent adhesive layer 62 has a refractive index that is substantially the same as that of the transparent member 24 and the glass substrate 30.

When an air layer is formed between the transparent member-side surface 22a of the planar light emitting body 22 and the planar light emitting body-side surface 24a of the transparent member 24, total reflection is caused at an interface between the planar light emitting body 22 and the air layer, and accordingly, light extraction efficiency may decrease. When the transparent adhesive layer 62 is provided between the transparent member-side surface 22a of the planar light emitting body 22 and the planar light emitting body-side surface 24a of the transparent member 24 as in the embodiment, total reflection is suppressed at the interface, and therefore, the light extraction efficiency is improved.

In the above-mentioned embodiment, each of the first recessed portion 44 and the second recessed portion 46 provided in the transparent member 24 has a triangular sectional shape. However, the shape of each of the first recessed portion 44 and the second recessed portion 46 is not limited to this shape. Hereinafter, a recessed portion in each modified example will be described.

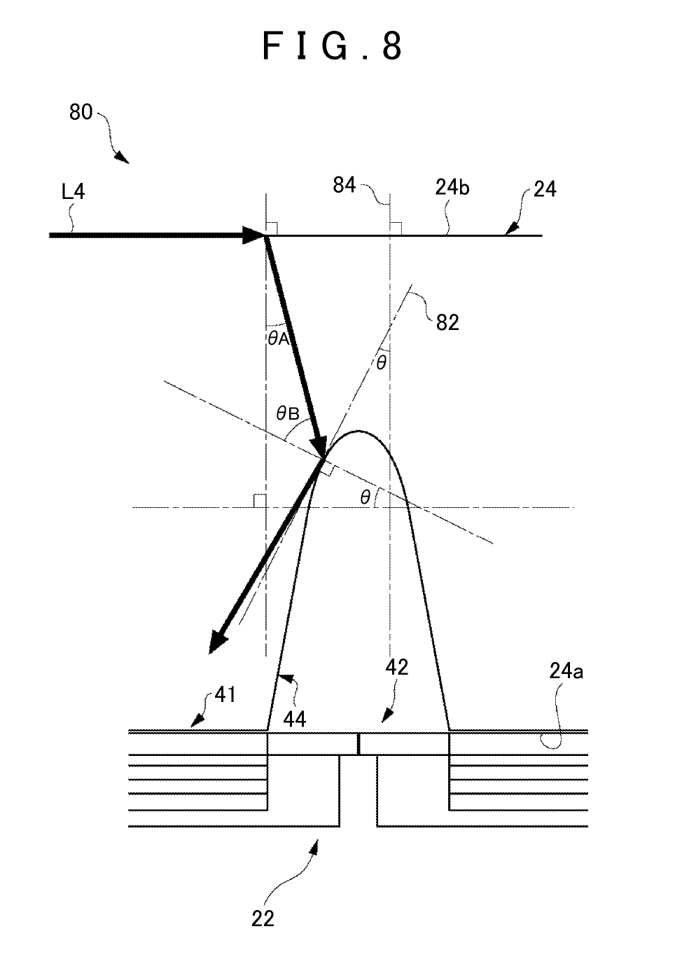

FIG. 8 is a view used for describing the recessed portion in the modified example. In a light emitting device 80 shown in FIG. 8, the constituent elements that are the same as or correspond to the constituent elements of the above-mentioned light emitting device 20 are denoted by the same reference numerals, and redundant descriptions thereof will be appropriately omitted. In the following descriptions as well, a focus is placed on the first recessed portion 44 as a representative example of the recessed portion.

As shown in FIG. 8, the first recessed portion 44 in the modified example is a recessed portion that has a sectional shape obtained by replacing an upper base of a trapezoidal shape with an arc. As in the case of FIG. 6, a light beam L4 that enters the light emitting surface 24b of the transparent member 24 at an incidence angle of 90 degrees will be described.

When 8 represents an angle between a tangent line 82 that is tangent to an arc of the first recessed portion 44 and a perpendicular line 84 that is perpendicular to the light emitting surface 24b of the transparent member 24, θ_{A} represents an output angle of the light beam L4, θ_{B} represents an incidence angle at which the light beam L4 is incident on an arc of the first recessed portion 44, “n” represents the refractive index of the transparent member 24, and θ_{C} represents a critical angle between the transparent member 24 and air, the following expression (3) is satisfied.

θ_{B}=90° −θ_{C}−θ . . . (3)

In order that the light beam L4 should be totally reflected at the arc of the first recessed portion 44 and should not be incident on the first non-light emitting portion 42, the incidence angle θ_{B} needs to be larger than the critical angle θ_{C}. That is, in a region where θ satisfies the following expression (4), the first non-light emitting portion 42 can be made unnoticeable.

θ<90° −2θ_{C} . . . (4)

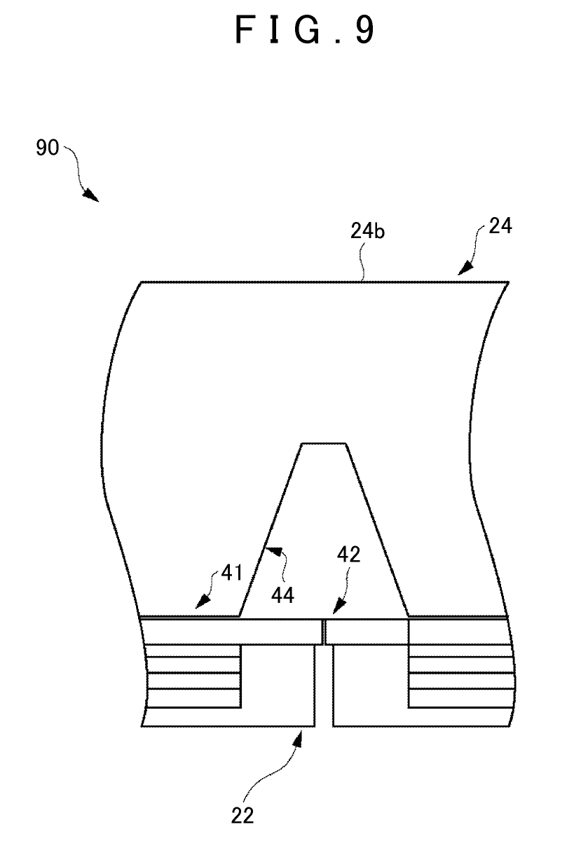

FIG. 9 is a view used for describing a recessed portion in another modified example. In a light emitting device 90 shown in FIG. 9, the constituent elements that are the same as or correspond to the constituent elements of the above-mentioned light emitting device 20 are denoted by the same reference numerals, and redundant descriptions thereof will be appropriately omitted. In the following descriptions as well, a focus is placed on the first recessed portion 44 as a representative example of the recessed portion.

As shown in FIG. 9, the first recessed portion 44 in the modified example is a recessed portion having a trapezoidal sectional shape. In the case where the first recessed portion 44 is a recessed portion having a trapezoidal sectional shape as well, at least part of light, which is directed toward the first non-light emitting portion 42 after entering the transparent member 24 from the outside, is internally reflected at the inclined surface of the first recessed portion 44 and reaches the light emitting portion 41. As a result, as compared to the case where the transparent member 24 is not provided, the first non-light emitting portion 42 is unlikely to be visually recognized from the outside (in other words, it is difficult to visually recognize, from the outside, the first non-light emitting portion 42).

Each of the first recessed portion 44 and the second recessed portion 46 may have an arc sectional shape, an elliptic sectional shape, or the like.

The embodiments of the invention are described above. However, persons skilled in the art can understand that the embodiments are example embodiments, the invention may be implemented in various modified examples in which the constituent elements or the processes are combined to each other, and the modified examples are included in the scope of the invention.

In the above-mentioned embodiments, the planar light emitting body is formed by disposing the plurality of organic electroluminescence panels adjacent to each other. However, the planar light emitting body may be formed by a single organic electroluminescence panel. Further, the planar light emitting body is not limited to the organic electroluminescence panel, as long as the planar light emitting body is an object having a planar surface from which light is emitted.

What is claimed is:

1. A light emitting device comprising:
a planar light emitting body that includes a light emitting portion having a planar surface from which light is emitted, and a non-light emitting portion from which light is not emitted, the non-light emitting portion being adjacent to the light emitting portion; and
a transparent member which is disposed to cover the planar light emitting body, and which has a recessed portion provided at a position facing the non-light emitting portion.

2. The light emitting device according to claim 1, wherein:
the planar light emitting body includes a plurality of light emitting panels disposed adjacent to each other; and
the non-light emitting portion includes an abutting portion at which the light emitting panels abut each other.

3. The light emitting device according to claim 1, wherein:
the planar light emitting body includes an electrode provided to supply power to the light emitting portion; and
the non-light emitting portion includes the electrode.

4. The light emitting device according to claim 1, wherein the recessed portion has a triangular sectional shape.

5. The light emitting device according to claim 1, wherein the recessed portion has a sectional shape obtained by replacing an upper base of a trapezoidal shape with an arc.

6. The light emitting device according to claim 1, wherein the recessed portion has a trapezoidal sectional shape.

7. A vehicular lamp comprising the light emitting device according to claim 1, the light emitting device being a light source of the vehicular lamp.
